(19) United States
(12) Patent Application Publication
(10) Pub. No.: US 2014/0279943 A1
(43) Pub. Date: Sep. 18, 2014

(54) FILE SYSTEM VERIFICATION METHOD AND INFORMATION PROCESSING APPARATUS

(71) Applicant: FUJITSU LIMITED, Kawasaki-shi (JP)

(72) Inventor: Kensuke Shiozawa, Kawasaki (JP)

(73) Assignee: FUJITSU LIMITED, Kawasaki-shi (JP)

(21) Appl. No.: 14/170,876

(22) Filed: Feb. 3, 2014

(30) Foreign Application Priority Data
Mar. 18, 2013 (JP) 2013-054570

(51) Int. Cl. G06F 17/30

(52) U.S. Cl. CPC G06F 17/30371
USPC 707/690

(57) ABSTRACT

An information processing apparatus includes an identifying unit and a verifying unit. The identifying unit identifies, among a plurality of unit storage areas in a volume storing therein one or more pieces of management object information managed by a file system and one or more pieces of management information corresponding one-to-one with the management object information pieces and used to manage the corresponding management object information pieces, one or more unit storage areas whose information has been updated within a predetermined time frame. The verifying unit verifies the consistency between the management object information pieces and the management information pieces in the file system using the information of the identified unit storage areas.

### CROSS-REFERENCE TO RELATED APPLICATION

This application is based upon and claims the benefit of priority of the prior Japanese Patent Application No. 2013-054570, filed on Mar. 18, 2013, the entire contents of which are incorporated herein by reference.

### FIELD

The embodiments discussed herein are related to a file system verification method and an information processing apparatus for checking consistency of a file system.

### BACKGROUND

A storage apparatus connected to a computer is provided with one or more volumes. A volume is a management unit of storage media. Input and output of data to and from a volume is managed by a file system. The file system has management information (metadata), for example, for each file. In association with, for example, a file created by the computer, the management information holds information about a location within a volume, at which data included in the file is stored. When an access request designating a file is made to the file system, for example, by application software of the computer, the file system accesses data in a storage location associated with the designated file based on management information of the file. With this, the application software is able to access desired data in the volume.

To allow the computer to accurately access data in volumes, it is important that management information held by the file system is consistent with data stored in the volumes. However, when the computer is in operation, inconsistency may arise between the management information of the file system and the data stored in the volumes. For example, if the management information is destroyed due to, for example, a software or hardware malfunction, inconsistency arises between the management information of the file system and the data in the volumes. If inconsistency of the file system is detected due to an input/output (I/O) error or the like after the inconsistency is left for a long period of time, restoration of the management information may already be difficult. Therefore, in order to improve reliability of the operation of the computer, a process called file system consistency check (FSCK) is implemented to periodically examine whether there is a file system inconsistency.

A FSCK is designed to read check-target management information of the file system and check the consistency of the management information with corresponding data stored in volumes. When a FSCK is run for the entire volumes to examine the consistency, a large amount of management information is read out, and therefore the FSCK takes a great deal of processing time. In addition, with an increase in electronic data of recent years, the size of volumes of computer systems operated in companies has increased. As a result, it has become difficult to complete the FSCK processing within a time frame not affecting the actual operation of the computer systems (for example, within nighttime hours for batch processing).

In view of the above, some technologies have been proposed which eliminate the use of FSCKs or speed up the FSCK processing in petabyte scale file systems. For example, it has been proposed to split such a large-scale file system into a plurality of small file systems. Another proposed technology is directed to the use of journaling in a file system. Journaling is a function for holding and managing file update history for restoration in case of failures.

Val Henson, Arjan van de Ven, Amit Gud, Zach Brown, “Chunkfs: Using divide-and-conquer to improve file system reliability and repair” HOTDEP'06 Proceedings of the 2nd conference on Hot Topics in System Dependability—Volume 2, Pages 7-7, 2006 Stephen C. Tweedie, “Journaling the Linux ext2fs Filesystem” Proceedings of the 4th Annual LinuxExpo, Durham, N.C., 1998

However, the conventional technologies are ineffective to sufficiently control an increase in the FSCK run time. For example, the use of the technology of splitting a file system into small file systems is limited to systems capable of operation with a set of small file systems. In addition, parallel execution of FSCKs on a number of file systems may exhaust server memory, which poses a limitation on reducing the size of file systems. As a result, once volumes increase above a certain level in size, an increase in the FSCK run time is uncontrollable.

The use of journaling enables the file system consistency to be restored quickly by continuing the journal processing even after an abrupt stop which contributes to file system inconsistency. Thus, journaling decreases the need of FSCKs. However, file system inconsistency may still arise from a malfunction of server software or hardware, and the use of journaling does not entirely eliminate the need of FSCKs.

### SUMMARY

According to one embodiment, there is provided a file system verification method. The file system verification method includes identifying, by a processor, among a plurality of unit storage areas in a volume storing therein one or more pieces of management object information managed by a file system and one or more pieces of management information corresponding one-to-one with the management object information pieces and used to manage the corresponding management object information pieces, one or more unit storage areas whose information has been updated within a predetermined time frame; and verifying, by the processor, consistency between the management object information pieces and the management information pieces in the file system using the information of the identified unit storage areas.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates an example of a functional configuration of an information processing apparatus according to a first embodiment;

FIG. 2 illustrates an example of a system configuration according to a second embodiment;

FIG. 3 illustrates an example of a hardware configuration of a server used in the second embodiment;

FIG. 4 illustrates an example of a hardware configuration of a storage apparatus used in the second embodiment;

FIG. 5 is a block diagram illustrating consistency check functions according to the second embodiment;

FIG. 6 illustrates an example of information managed by the storage apparatus;

FIG. 7 illustrates details of a file system volume area;

FIG. 8 illustrates a relationship among information items stored in the file system volume area;

FIG. 9 illustrates an example of a method for managing block update differences;

FIG. 10 illustrates an example of a data structure of a WBMAP;

FIG. 11 is a flowchart illustrating an example of a FSCK procedure;

FIG. 12 is a flowchart illustrating an example of an update difference FSCK procedure;

FIG. 13 is a first half of a flowchart illustrating an example of a file allocation check process;

FIG. 14 illustrates an example of a cached block and cache tables;

FIG. 15 is a second half of the flowchart illustrating the example of the file allocation check process;

FIG. 16 illustrates an example of a VBMAP;

FIG. 17 illustrates an example of a VFBMAP;

FIG. 18 is a first half of a flowchart illustrating an example of a block allocation check procedure;

FIG. 19 is a second half of the flowchart illustrating the example of the block allocation check procedure;

FIG. 20 is a first half of a flowchart illustrating an example of a directory structure check procedure; and

FIG. 21 is a second half of the flowchart illustrating the example of the directory structure check procedure.

### DESCRIPTION OF EMBODIMENTS

Several embodiments will be described below with reference to the accompanying drawings, wherein like reference numerals refer to like elements throughout. Note that two or more of the embodiments below may be combined for implementation in such a way that no contradiction arises.

### (a) First Embodiment

FIG. 1 illustrates an example of a functional configuration of an information processing apparatus according to a first embodiment. An information processing apparatus CP includes a volume 1, a pre-update information storing unit 2, a updated area recording unit 3, a pre-update information storage unit 4, an updated area information storage unit 5, an identifying unit 6, and a verifying unit 7.

The volume 1 is a storage area for storing pieces of management object information (hereinafter simply “management object information pieces”) managed by a file system and pieces of management information (“management information pieces”) used to manage the management object information pieces. The volume 1 is provided with a plurality of unit storage areas 1a. The unit storage areas 1a are, for example, storage areas called blocks.

When information in a unit storage area is updated within a predetermined time frame, the pre-update information storing unit 2 stores pre-update information of the unit storage area in the pre-update information storage unit 4. The predetermined time frame here means, for example, the period to the current time after a FSCK run.

When information in a unit storage area is updated within the predetermined time frame, the updated area recording unit 3 enters, on updated area information 5a, a record regarding the update of the information of the unit storage area. For example, the updated area information 5a includes bits corresponding one-to-one with the plurality of unit storage areas 1a, and the value of each bit indicates whether the corresponding unit storage area has been updated. In this case, the updated area recording unit 3 changes, within the updated area information 5a, the value of a bit corresponding to the unit storage area whose information has been updated in such a manner as to indicate that the corresponding unit storage area has been updated.

The pre-update information storage unit 4 stores therein pre-update information. The updated area an information storage unit 5 stores therein the updated area information 5a.

The identifying unit 6 identifies, among the plurality of unit storage areas 1a of the volume 1, one or more unit storage areas whose information has been updated within the predetermined time frame. For example, the identifying unit 6 identifies, as a unit storage area whose information has been updated within the predetermined time frame, each unit storage area whose corresponding bit in the updated area information 5a indicates that the unit storage area has been updated.

With respect to information stored in each unit storage area identified by the identifying unit 6, the verifying unit 7 checks consistency between a management object information piece and a corresponding management information piece in the file system. For example, the verifying unit 7 verifies (checks) the consistency when the number of updated unit storage areas exceeds a predetermined value. The management object information pieces are, for example, directories and files. Note that directories may be referred to as folders. The management information pieces are information called, for example, metadata. Inodes are an example of metadata. The consistency check includes a check for the consistency between a management object information piece and a corresponding management information piece as well as a check for the consistency among a plurality of management information pieces.

For example, the verifying unit 7 acquires, from the pre-update information storage unit 4, pre-update information 8a having been stored at the start of the predetermined time frame in a unit storage area which has undergone an information update within the predetermined time frame. In addition, the verifying unit 7 acquires, from the volume 1, updated information 8b stored in the unit storage area at the end of the predetermined time frame. Subsequently, based on the pre-update information 8a and the updated information 8b, the verifying unit 7 checks the consistency between a change in a management object information piece and a change in a management information piece associated with the management object information piece within the predetermined time frame.

Note that the verifying unit 7 is capable of checking the consistency from a plurality of perspectives. In order to check the consistency from various perspectives, the verifying unit 7 includes a file allocation verifying unit 7a, a block allocation verifying unit 7b, and a directory structure verifying unit 7c.

The file allocation verifying unit 7a checks the consistency between changes in first allocation information and changes in management information pieces within the predetermined time frame. The first allocation information indicates the allocation or non-allocation of the individual management information pieces to management object information pieces (directories and files). For example, an identification number is given to each of the management information pieces. In the first allocation information, with respect to each of the management information pieces, the presence or absence of a corresponding management object information piece is set in association with the identification number of the management information piece. The first allocation information changes with management object information pieces being newly created and deleted. In addition, when a management object information piece is newly created or deleted, for example, the type of a management information piece corresponding to the management object information piece is changed. In view of this, the file allocation verifying unit 7a checks the consistency between changes in management information pieces and changes in the first allocation information indicating the allocation or non-allocation of a management object information piece corresponding to each of the management information pieces. Then, if an inconsistency is found, the file allocation verifying unit 7a outputs an error.

The block allocation verifying unit 7b checks the consistency between the following changes within the predetermined time frame: changes in second allocation information indicating the allocation or non-allocation of the individual unit storage areas 1a to management object information pieces; and changes in the allocation of the individual unit storage areas 1a to the management object information pieces, indicated by corresponding management information pieces. For example, in the second allocation information, a bit is provided for each of the unit storage areas 1a to indicate whether the unit storage area 1a has been allocated to a management object information piece as a storage area for data of the management object information piece. When a unit storage area is newly allocated to a management object information piece or when the allocation of a unit storage area is cancelled, a bit in the second allocation information, corresponding to the unit storage area, changes in value. In this case, in a management information piece corresponding to the management object information piece, information about the allocated unit storage area is also changed. In view of this, the block allocation verifying unit 7b checks the consistency between changes in the second allocation information and changes in the allocation of the individual unit storage areas 1a to management object information pieces, indicated by corresponding management information pieces, within the predetermined time frame. Then, if an inconsistency is found, the block allocation verifying unit 7b outputs an error.

In addition, the block allocation verifying unit 7b checks the consistency between the following changes within the predetermined time frame: changes in unit storage areas allocated to individual management object information pieces; and changes in the number of unit storage areas allocated to the individual management object information pieces, indicated by management information pieces corresponding to the individual management object information pieces. For example, a management information piece corresponding to a management object information piece includes unit-storage-area allocation information indicating unit storage areas allocated to the management object information piece as a data storage area and unit-storage-area count information indicating the number of the allocated unit storage areas. When a unit storage area is newly allocated to the management object information piece or when the allocation of a unit storage area to the management object information piece is cancelled, the unit-storage-area allocation information of the corresponding management information piece is updated. In this case, in the management information piece, the number of unit storage areas allocated to the management object information piece is also updated. In view of this, the block allocation verifying unit 7b checks the consistency between changes in unit storage areas allocated to individual management object information pieces and changes in the number of the allocated unit storage areas indicated by management information pieces corresponding to the individual management object information pieces. Then, if an inconsistency is found, the file allocation verifying unit 7b outputs an error.

The directory structure verifying unit 7c calculates the number of directories to which each file belongs, based on changes in entries of the file to the directories within the predetermined time frame. In addition, the directory structure verifying unit 7c calculates, based on a management information piece corresponding to the file, changes in the number of directories to which the file belongs within the predetermined time frame. Subsequently, the directory structure verifying unit 7c checks the consistency of the number of directories to which each file belongs by comparing the number calculated based on the entries of the file to the directories and the number calculated based on the management information piece corresponding to the file. Then, if an inconsistency is found, the directory structure verifying unit 7c outputs an error.

According to the above-described information processing apparatus CP, an update of a management object information piece in the volume 1 is accompanied by an update of a management information piece corresponding to the management object information piece. As for unit storage areas storing therein the updated management object information piece and management information piece, pre-update information of the unit storage areas is then stored in the pre-update information storage unit 4. In addition, information indicating the updated unit storage areas is set in the updated area information 5a.

Assume here that, according to the first embodiment, the file system consistency of the volume 1 has been confirmed at a certain point in time. Then, the file system consistency is checked at a predetermined interval according to the first embodiment. For example, if the number of unit storage areas updated after the previous FSCK exceeds a predetermined number, a FSCK is run. In the FSCK processing, the identifying unit 6 identifies the unit storage areas updated after the previous FSCK. Then, with respect to information included in the unit storage areas identified by the identifying unit 6, the verifying unit 7 checks the consistency between individual management object information pieces and management information pieces associated with the management object information pieces. For example, as for the identified unit storage areas, the verifying unit 7 acquires the pre-update information 8a and the updated information 8b, and compares these two to thereby recognize changes in the information after the previous FSCK. Subsequently, the verifying unit 7 determines whether changes in the management object information pieces and changes in the associated management information pieces are consistent with each other. In the case where the consistency of the entire file system has been confirmed in the previous FSCK and, then, the consistency of the content of subsequent changes is confirmed, the consistency of the entire file system is determined to be maintained.

Thus, according to the first embodiment, the file system consistency is checked using information of unit storage areas in the volume 1, updated after the previous FSCK. In this manner, each FSCK limits its check target only to updated information, thus reducing the amount of information used for the FSCK, which in turn decreases the time taken for the FSCK. Because the amount of the updated information does not directly depend on the size of the volume 1, it is possible to control an increase in the FSCK run time associated with an increase in the size of the volume 1.

Note that if the volume 1 increases in size, information in the file system is likely to be updated more frequently. In that case, an increase in the run time of each FSCK may be controlled by shortening the FSCK interval.

Note that the pre-update information storing unit 2, the updated area recording unit 3, the identifying unit 6, and the verifying unit 7 may be implemented, for example, by a processor of the information processing apparatus CP. In addition, the volume 1, the pre-update information storage unit 4, and the updated area information storage unit 5 may be implemented, for example, by a storage medium, such as a hard disk device, of the information processing apparatus CP.

Note that, in FIG. 1, each line connecting the individual components represents a part of communication paths, and communication paths other than those illustrated in FIG. 1 are also configurable.

### (b) Second Embodiment

The second embodiment is designed to manage update differences of the file system in the storage apparatus. The term “update differences” in the second embodiment means information updated after the previous FSCK.

FIG. 2 illustrates an example of a system configuration according to the second embodiment. According to the second embodiment, there is provided a storage apparatus 200 connected to a server 100. The server 100 is a computer for managing volumes in the storage apparatus 200 using a file system. The server 100 is connected to terminals 21 and 22 via a network 10. The terminals 21 and 22 access the server 100 via the network 10 to thereby access data stored in the storage apparatus 200.

FIG. 3 illustrates an example of a hardware configuration of a server used in the second embodiment. Overall control of the server 100 is exercised by a processor 101. To the processor 101, a RAM (random access memory) 102 and a plurality of peripherals are connected via a bus 100a. The processor 101 may be a multi-processor. The processor 101 is, for example, a CPU (central processing unit), a MPU (micro processing unit), or a DSP (digital signal processor). At least part of the functions of the processor 101 may be implemented as an electronic circuit, such as an ASIC (application specific integrated circuit) and a PLD (programmable logic device).

The RAM 102 is used as a main storage device of the server 100. The RAM 102 temporarily stores at least part of an OS (operating system) program and application programs to be executed by the processor 101. The RAM 102 also stores therein various types of data to be used by the processor 101 for its processing.

The peripherals connected to the bus 100a include a HDD (hard disk drive) 103, a graphics processing unit 104, an input interface 105, an optical drive unit 106, a device connection interface 107, a network interface 108, and a storage interface 109.

The HDD 103 magnetically writes and reads data to and from a built-in disk, and is used as a secondary storage device of the server 100. The HDD 103 stores therein the OS program, application programs, and various types of data. Note that a semiconductor storage device such as a flash memory may be used as the secondary storage device in place of the HDD 103.

To the graphics processing unit 104, a monitor 11 is connected. According to an instruction from the processor 101, the graphics processing unit 104 displays an image on a screen of the monitor 11. A cathode ray tube (CRT) display or a liquid crystal display, for example, may be used as the monitor 11.

To the input interface 105, a keyboard 12 and a mouse 13 are connected. The input interface 105 transmits signals sent from the keyboard 12 and the mouse 13 to the processor 101. Note that the mouse 13 is just an example of pointing devices, and a different pointing device such as a touch panel, a tablet, a touch-pad, and a trackball, may be used instead.

The optical drive unit 106 reads data recorded on an optical disk 14 using, for example, laser light. The optical disk 14 is a portable recording medium on which data is recorded in such a manner as to be read by reflection of light. Examples of the optical disk 14 include a digital versatile disc (DVD), a DVD-RAM, a compact disk read only memory (CD-ROM), a CD recordable (CD-R), and a CD-rewritable (CD-RW).

The device connection interface 107 is a communication interface for connecting peripherals to the server 100. To the device connection interface 107, for example, a memory device 15 and a memory reader/writer 16 may be connected. The memory device 15 is a recording medium having a function for communicating with the device connection interface 107. The memory reader/writer 16 is a device for writing and reading data to and from a memory card 17. The memory card 17 is a card type recording medium.

The network interface 108 is connected to the network 10. Via the network 10, the network interface 108 transmits and receives data to and from different computers and communication devices.

The storage interface 109 is connected to the storage apparatus 200. The storage interface 109 communicates with the storage apparatus 200 to thereby write and read data to and from the storage apparatus 200.

The hardware configuration described above achieves the processing functions of the second embodiment. Note that the information processing apparatus CP according to the first embodiment of FIG. 1 may be constructed with the same hardware configuration as the server 100 of FIG. 3.

The server 100 achieves the processing functions of the second embodiment, for example, by implementing a program stored in a computer-readable recording medium. The program describing processing contents to be implemented by the server 100 may be stored in various types of recording media. For example, the program to be implemented by the server 100 may be stored in the HDD 103. The processor 101 loads at least part of the program stored in the HDD 103 into the RAM 102 and then runs the program. In addition, the program to be implemented by the server 100 may be stored in a portable recording medium, such as the optical disk 14, the memory device 15, and the memory card 17. The program stored in the portable recording medium becomes executable after being installed on the HDD 103, for example, under the control of the processor 101. Alternatively, the processor 101 may run the program by directly reading it from the portable recording medium.

FIG. 4 illustrates an example of a hardware configuration of a storage apparatus used in the second embodiment. The storage apparatus 200 includes a plurality of HDDs 211, 212, and . . . , a communication interface (I/F) 221, and a controller module (CM) 230.

The HDDs 211, 212, and . . . are an example of storage devices. Note that the storage apparatus 200 may be provided with solid-state drives (SSDs) in place of the HDDs 211, 212, and . . . .

The communication interface 221 is used to communicate with the server 100. For example, the communication interface 221 receives a request from the server 100 and then transfers the received request to the controller module 230. The communication interface 221 also receives a response to the request from the controller module 230 and then transmits the response to the server 100.

The controller module 230 is a built-in computer of the storage apparatus 200 and manages resources, such as HDDs, of the storage apparatus 200. For example, to the controller module 230, the HDDs 211, 212, and . . . are connected. The controller module 230 manages resources (storage functions) provided by the connected HDDs 211, 212, and . . . . The controller module 230 is capable of generating a RAID (redundant array of inexpensive disks) by combining a plurality of HDDs under its control and logically using the generated RAID group as a single volume.

The controller module 230 includes a CPU 231, a memory 232, a cache memory 233, and a plurality of device adapters (DAs) 234, 235, and . . . . The individual components of the controller module 230 are connected to each other by an internal bus 239.

The CPU 231 exercises overall control over the controller module 230. For example, the CPU 231 controls the number of commands input from the communication interface 221. Note that the controller module 230 may include a plurality of CPUs. In that case, the plurality of CPUs exercise overall control over the controller module 230 in cooperation with each other.

The memory 232 stores various types of information used for control exercised by the controller module 230. The memory 232 also stores a program in which processes to be executed by the CPU 231 are described. A nonvolatile memory, such as a flash memory, may be used as the memory 232.

The cache memory 233 is a memory for temporarily storing data to be input and output to and from the HDDs 211, 212, and . . . . The device adapters 234, 235, and . . . are connected to the HDDs 211, 212, and . . . , respectively, and input and output data to and from the HDDs connected thereto.

In a system having the above-described hardware configurations, volumes of the storage apparatus 200 are managed by the file system of the server 100. Due to a hardware failure of the storage apparatus 200 or a software malfunction of the server 100, an inconsistency may arise between management information of the file system and data in the volumes of the storage apparatus 200. In order not to leave such an inconsistency, the server 100 runs a FSCK. In the FSCK of the second embodiment, the consistency regarding data updated after the previous FSCK run is checked.

FIG. 5 is a block diagram illustrating consistency check functions according to the second embodiment. In the second embodiment, the storage apparatus 200 manages block update differences. The server 100 acquires information of block update differences from the storage apparatus 200 and checks the consistency regarding information updated after the previous FSCK.

The server 100 includes a plurality of applications 111, 112, and 113 and a file system driver (FSD) 120. The applications 111, 112, and 113 individually execute processing in response to requests from the terminals 21 and 22. The individual applications 111, 112, and 113 read, for example, data from the storage apparatus 200 in the course of the processing execution. In addition, the applications 111, 112, and 113 may write processing results to the storage apparatus 200 in the course of the processing execution. Data writing and reading to and from the storage apparatus 200 by the applications 111, 112, and 113 are performed via the FSD 120.

The FSD 120 carries out file system processing. For example, the FSD 120 manages storage locations of data included in directories and files using management information. The management information is, for example, inodes. Although the following example uses inodes as management information, inodes are merely an example of the management information and information other than inodes may be used as the management information of the file system.

The FSD 120 manages logical volumes defined in a storage area provided by the HDDs 211 to 214 of the storage apparatus 200. For example, the FSD 120 manages directory structures of the logical volumes and files stored in directories. Each file is uniquely identified, for example, by a path identifying a location in a directory and a file name. In addition, the FSD 120 generates inodes corresponding one-to-one with directories and files and manages the generated inodes in the logical volumes. Each inode corresponding to a file contains information including an inode number and logical block addresses (LBA) in a logical volume, at which data included in the file is stored. Each inode corresponding to a directory contains information including file names of files belonging to the directory and an inode number.

Then, the FSD 120 runs a FSCK at a predetermined timing. For example, the FSD 120 is capable of running a FSCK at a preset time. In addition, the FSD 120 is capable of running a FSCK when the amount of data updated reaches or exceeds a predetermined threshold. Thus, by running a FSCK when the amount of data updated reaches or exceeds the predetermined threshold, the amount of data used to determine the consistency in the FSCK is controlled, which in turn controls the FSCK run time.

When carrying out a FSCK, the FSD 120 starts a FSCK executing unit 130. The FSCK executing unit 130 may be installed inside the FSD 120, or may be implemented as an external function callable from the FSD 120. The FSCK executing unit 130 executes a FSCK on data updated after the previous FSCK. In order to run a FSCK, the FSCK executing unit 130 includes a file allocation checking unit 131, a block allocation checking unit 132, a directory structure checking unit 133, and a cleanup processing unit 134.

The file allocation checking unit 131 checks the file system consistency in terms of file allocation status of inodes. For example, based on inodes updated after the previous FSCK run, the file allocation checking unit 131 determines the update content regarding file allocation status of each of the updated modes. The “update content regarding file allocation status of each of the updated inodes” is information indicating, for example, that the inode corresponds to a file newly created or a file deleted after the previous FSCK run.

In addition, the file allocation checking unit 131 determines the update content regarding file allocation status also based on an inode map obtained immediately after the previous FSCK run and a current mode map. Each inode map contains bits corresponding one-to-one with inodes, and the value of each bit indicates whether the corresponding inode is in use or not. The file allocation checking unit 131 determines whether the update content regarding file allocation status based on the updated inodes matches the update content regarding file allocation status based on the mode maps. If there is an inode having a mismatch between these two, the file allocation checking unit 131 determines that there is an inconsistency in the content of the inode.

The block allocation checking unit 132 checks the file system consistency in terms of block allocation status. For example, the block allocation checking unit 132 identifies the content of change in block allocation after the previous FSCK run based on changes in blocks allocated to inodes between the previous FSCK run and the current FSCK run. The “block allocation” means allocation of blocks to each file as a data storage location. Note that in each inode, blocks allocated to a file corresponding to the inode are designated by block numbers of a logical volume (logical block addresses). The “change in block allocation” here refers to, for example, allocation of new blocks and release of blocks after the block allocation is cancelled. In addition, in each inode, the number of blocks allocated to the inode is designated. In view of this, as for each updated inode after the previous FSCK run, the block allocation checking unit 132 checks the consistency between the following two: a difference in the number of allocated blocks between the previous FSCK run and the current FSCK run; and the content of change in block allocation after the previous FSCK run. For example, the block allocation checking unit 132 determines that there is an inconsistency if, as for an updated inode, a value obtained by subtracting the number of blocks released from the number of blocks newly allocated does not match a difference in the number of allocated blocks designated in the inode between the previous FSCK run and the current FSCK run.

In addition, a difference in file size may be checked. For example, the file allocation checking unit 131 multiplies the difference in the number of allocated blocks by storage size per block, to thereby calculate a change in the total storage size of the allocated blocks after the previous FSCK run. Subsequently, the file allocation checking unit 131 compares the change in the total storage size of the allocated blocks with a difference in the file size between the previous FSCK run and the current FSCK run, to check whether the two match each other. Note that each inode indicates the size of a corresponding file. The block allocation checking unit 131 determines that there is an inconsistency if the change in the total storage size of the allocated blocks does not match the difference in the file size.

In addition, the block allocation checking unit 132 acquires bitmap information indicating updated blocks (update bitmap; hereinafter, referred to as “WBMAP”) from a volume manager (VMGR) 240 of the storage apparatus 200. Subsequently, as for each updated inode, the block allocation checking unit 132 checks the presence or absence of inconsistency between updated blocks recognized based on the inode and the WBMAP.

The directory structure checking unit 133 checks the file system consistency in terms of directory structures. For example, the directory structure checking unit 133 identifies, among directory-type inodes, inodes whose directory entry file has been updated after the previous FSCK. Subsequently, as for each of the updated directory entry files, the directory structure checking unit 133 compares pre-update content and updated content to thereby determine added and deleted entries (each including a file name and an inode number). According to addition and deletion of entries, the directory structure checking unit 133 updates reference increase and decrease information of an inode corresponding to each of the entries. Then, as for each of the updated directory-type inodes, the directory structure checking unit 133 determines the consistency between the following two: a change in the number of references indicated by the reference increase and decrease information; and a change in the number of references recognized by comparing pre-update content (i.e. content obtained immediately after the previous FSCK) and updated content (i.e. current content) of the directory-type inode.

The cleanup processing unit 134 deletes temporal information created in the course of the current FSCK and also prepares the next FSCK. For example, the cleanup processing unit 134 releases storage areas for inode data and cached blocks in the memory. In addition, the cleanup processing unit 134 transmits, to the VMGR 240, an instruction to clear update bitmaps.

The storage apparatus 200 includes the VMGR 240, which records a file system image on one or more non-volatile storage media. Then, the VMGR 240 performs block I/O of logical volumes in response to a file/directory I/O request from the FSD 120. For example, in response to an I/O request designating a logical block number of an access target, the VMGR 240 determines a pair of a hard disk number and a physical block number corresponding to the logical block. Subsequently, the VMGR 240 accesses the corresponding physical block on the corresponding hard disk according to the I/O request.

The VMGR 240 manages update differences in blocks. In order to manage block update difference information, the VMGR 240 includes a block update difference managing unit 241. The block update difference managing unit 241 has the following functions, for example.

(1) The block update difference managing unit 241 manages update bitmaps (WBMAP) in which an LBA of each updated block is represented by bit 1 and an LBA of each block other than that is represented by bit 0.

(2) The block update difference managing unit 241 saves blocks, to each of which an update request has been made, in another area as pre-update block data (BIBLK), and separately manages LBAs at which the blocks are saved.

(3) Upon receiving a WBMAP reference request (WBMAP_REQ) from the FSD 120, the block update difference managing unit 241 responds to the FSD 120 with a WBMAP including an LBA designated in the request.

(4) Upon receiving a BIBLK reference request (BIBLK_REQ) from the FSD 120, the block update difference managing unit 241 responds to the FSD 120 with a BIBLK of an LBA designated in the request.

(5) Upon receiving a WBMAP reset request (WBMAP_CLR) from the FSD 120, the block update difference managing unit 241 clears all bits of a WBMAP including an LBA designated by the request. At this point, the block update difference managing unit 241 discards BIBLKs corresponding to bits which have been set and their LBA management entries.

(6) Upon receiving a BIBLK total amount reference request (BIBLKSZ_REQ) from the FSD 120, the block update difference managing unit 241 responds to the FSD 120 with the total number of bytes of BIBLKs accumulating at that point in time.

Next described is information managed by the storage apparatus 200. FIG. 6 illustrates an example of information managed by a storage apparatus. The storage apparatus 200 manages storage areas of the HDDs 211 to 214. For example, the storage apparatus 200 establishes, in the HDDs 211 to 214, a file system volume area 250, a pre-update data storage area 260, and an update bitmap (WBMAP) storage area 270.

The file system volume area 250 is a storage area for logical volumes accessible from the server 100. The pre-update data storage area 260 is a storage area for pre-update contents of blocks whose data has been updated after the previous FSCK run. The update bitmap storage area 270 is a storage area for bitmap information (WBMAPs) indicating whether each block in the logical volumes has been updated after the previous FSCK.

FIG. 7 illustrates details of a file system volume area. The file system volume area 250 includes a superblock area 251, logical volume-specific bitmap areas 252 and 255, logical volume-specific inode block areas 253 and 256, and logical volume-specific data block areas 254 and 257. For example, a group of the bitmap area 252, the inode block area 253, and the data block area 254 forms one logical volume managed by the file system. Similarly, a group of the bitmap area 255, the inode block area 256, and the data block area 257 forms another logical volume managed by the file system.

The superblock area 251 is a storage area for superblocks, each of which is a storage area for metadata used to manage a logical volume. Each superblock includes information, such as the total number of inodes and the size of the file system.

The bitmap areas 252 and 255 are storage areas for bitmaps indicating whether individual inode blocks and data blocks are in use. In the bitmap areas 252 and 255, for example, each bit corresponding to a block in use is set to “1”, and each bit corresponding to an unused block is set to “0”. The inode block areas 253 and 256 are storage areas for inodes. Each inode is stored in a block-based storage area of the inode block areas 253 and 256. The data block areas 254 and 257 are storage areas for data. Data included in files is stored in block-based storage areas of the data block areas 254 and 257.

Next descried is a relationship among information items stored in the file system volume area 250. FIG. 8 illustrates a relationship among information items stored in a file system volume area. The bitmap area of FIG. 8 stores therein an inode map 252a and a block bitmap 252b.

The inode map 252a contains bits corresponding one-to-one with inodes included in the file system. Each bit is associated with an inode number, and indicates whether an inode having the corresponding mode number is in use. In the example of FIG. 8, if an mode is in use, the corresponding bit is set to “1”, and if an inode is not used, the corresponding bit is set to “0”.

The block bitmap 252b contains bits corresponding one-to-one with blocks of a logical volume concerned. Each bit is associated with an LBA, and indicates whether a data block having the corresponding LBA is in use. In the example of FIG. 8, if a data block is in use, the corresponding bit is set to “1”, and if a data block is not used, the corresponding bit is set to “0”.

The inode block area contains blocks individually associated with inode numbers, and each mode of a directory or a file is stored in a block corresponding to an inode number of the directory or the file. Note that each inode corresponding to a directory includes a pointer, for example, to a data block storing therein a directory entry file. Each inode corresponding to a file includes pointers to blocks storing therein data contained in the file.

The data block area stores therein directory entry files and data. The directory entry file includes entries of child directories or files belonging to the directory. Each entry includes information uniquely indicating a child directory or a file. For example, an entry of a file includes a pair of a file name and an mode number.

Note that the inode map 252a and the block bitmap 252b stored in the bitmap area and inodes stored in the inode block area are an example of the management information according to the first embodiment of FIG. 1. Next descried is a method of managing block update differences implemented by the block update difference managing unit 241 of the VMGR 240. FIG. 9 illustrates an example of a method for managing block update differences. Assume here that data in a block of the inode block area 253 or 256 or the data block area 254 or 257 of the file system volume area 250 has been updated. In this case, the block update difference managing unit 241 stores, in the pre-update data storage area 260, a pre-update image (before image (BI)) 261 representing pre-update content of the updated block. Subsequently, the block update difference managing unit 241 stores an updated image (after image (AI)) 258 representing updated content in an update target block of the file system volume area 250.

The block update difference managing unit 241 manages the before image 261 stored in the pre-update data storage area 260 using a before-image control table 280. The before-image control table 280 is a B+tree 281, which is a type of tree structure allowing insertions, searches, and deletions of before images. The tree structure of the B+tree 281 used as the before-image control table 280 is configured in such a manner as to use block numbers (LBAs) of a logical volume concerned as keys and allow a path to be traced to a node at the lowest level (leaf node) corresponding to an LBA. Each leaf node of the B+tree 281 stores therein a block number of a block located in the pre-update data storage area 260 and storing therein a before image, in association with an LBA of a corresponding updated block. The use of the B+tree 281 enables rapid identification of a block number of a block storing therein a before image corresponding to the LBA of an updated block.

In addition, the block update difference managing unit 241 manages whether each block in the logical volumes has been updated, using WBMAPs. FIG. 10 illustrates an example of a data structure of a WBMAP. A WBMAP 271 includes bits corresponding to individual blocks in a management-object logical volume. A value of each bit indicates whether a corresponding block has been updated. For example, each bit corresponding to an updated block is set to “1”, and each bit corresponding to a non-updated block is set to “0”.

In the example of FIG. 10, the WBMAP 271 is a variable-length array of 64-bit integers. That is, each entry of the WBMAP 271 is represented by a 64-bit integer. The number of entries is obtained by dividing the volume size of the logical volume by a block size and further dividing the result by the number of bits per entry (64). A single entry indicates an updated/non-updated state for each of 64 blocks. In the case of arranging the entries in ascending order from the 0^{th} entry, for example, the N^{th} entry (N is an integer equal to or greater than 0) indicates an updated/non-updated state for each of the (64×N)^{th} block to the (64×N+63)^{th} block.

Upon request of the server 100, the VMGR 240 transmits the WBMAP 271 to the server 100. For example, upon receiving a designation of a specific range of block numbers from the server 100, the VMGR 240 may transmit part of the WBMAP 271 (a part corresponding to the designated range of block numbers) to the server 100.

Note that the WBMAP 271 is provided, for example, for each area of the file system volume area 250 illustrated in FIG. 7. For example, WBMAPs are provided individually for each of the bitmap areas 252 and 255.

As described above, by holding the block update differences after the previous FSCK and the WBMAP 271, it is possible to easily recognize updated blocks and updated contents in a subsequent FSCK.

Next described is a FSCK procedure carried out by the FSD 120 according to the second embodiment. FIG. 11 is a flowchart illustrating an example of a FSCK procedure.

[Step S101] The FSD 120 starts in response to a start request from an operation system (OS). At this point, the FSD 120 starts up the FSCK executing unit 130 in the course of its own start process. For example, the FSD 120 outputs a request for starting the FSCK executing unit 130 to the OS. Then, the FSCK executing unit 130 is started to initiate processing for a FSCK.

[Step S102] The FSCK executing unit 130 acquires the total amount of BIBLKs. For example, the FSCK executing unit 130 outputs a request for referring to the total amount of BIBLKs (BIBLKSZ_REQ) to the storage apparatus 200. Then, the VMGR 240 of the storage apparatus 200 responds to the FSCK executing unit 130 with the total amount of BIBLKs. The FSCK executing unit 130 receives the total amount of BIBLKs sent from the VMGR 240.

[Step S103] The FSCK executing unit 130 determines whether the total amount of BIBLKs is equal to or more than a predetermined upper limit. For example, the FSCK executing unit 130 compares the total amount of BIBLKs with the predetermined upper limit to thereby determine whether the total amount of BIBLKs is equal to or more than the predetermined upper limit. If the total amount of BIBLKs is equal to or more than the predetermined upper limit, the process proceeds to step S104. On the other hand, if the total amount of BIBLKs is less than the upper limit, the process proceeds to step S110.

[Step S104] The FSCK executing unit 130 causes suspension of the FSD 120, which means suspending functions of the FSD 120. For example, the FSCK executing unit 130 instructs the FSD 120 to suspend the functions. In response, the FSD 120 writes information on the file system held in a memory out to the storage apparatus 200. Subsequently, the FSD 120 stops receiving requests for accessing logical volumes from applications and the like.

[Step S105] The FSCK executing unit 130 runs a FSCK on update differences of the file system. This process is described in detail later (see FIG. 12).

[Step S106] The FSCK executing unit 130 determines whether the FSCK has been successfully completed with no inconsistency detected. For example, an exit code has been prepared in the FSCK executing unit 130. If the FSCK is completed successfully with no inconsistency detected, a code indicating a success is set in the exit code. On the other hand, if an inconsistency is detected in the FSCK, an error is set in the exit code. Consequently, the FSCK executing unit 130 determines that the FSCK has been successfully completed if the value of the exit code indicates a success, and determines that the FSCK has not been successfully completed with an inconsistency detected if the value of the exit code indicates an error. If the FSCK has been successfully completed, the process proceeds to step S107. On the other hand, if an inconsistency has been detected and the FSCK has not been successfully completed, the process proceeds to step S111.

[Step S107] When the FSCK is successfully completed, the cleanup processing unit 134 of the FSCK executing unit 130 carries out a memory cleanup process. For example, the cleanup processing unit 134 releases storage areas for check-target inodes and cached blocks in the memory.

[Step S108] The cleanup processing unit 134 carries out a process of resetting update differences of logical volumes. For example, the cleanup processing unit 134 transmits, to the storage apparatus 200, a WBMAP_CLR instruction designating all the LBAs as objects to be cleared. In response, the block update difference managing unit 241 clears all the bits in WBMAPs to “0”. At this point, the block update difference managing unit 241 releases BIBLKs corresponding to the cleared bits from the pre-update data storage area 260. Furthermore, the block update difference managing unit 241 deletes leaf nodes corresponding to the cleared bits (entries pointing to before images) from the before-image control table 280.

[Step S109] The FSCK executing unit 130 carries out a process of resuming the FSD 120. For example, the FSCK executing unit 130 causes the FSD 120 to resume receiving I/O requests from applications.

[Step S110] The FSCK executing unit 130 waits for a predetermined period of time. For example, the FSCK executing unit 130 starts time measurement using a timer and then continually determines whether the predetermined waiting time has elapsed. Subsequently, when the waiting time has elapsed from the start of the time measurement, the FSCK executing unit 130 proceeds to step S102 to start the next FSCK.

[Step S111] When an inconsistency is detected in the update difference FSCK, the FSCK executing unit 130 causes the FSD 120 to stop. For example, the FSCK executing unit 130 transmits a command to stop the processing of the FSD 120 to the OS.

In the above-described manner, the FSCK for update differences is run periodically. Then, the FSD 120 is stopped if an inconsistency is detected in the file system. Note that in the case where a file system inconsistency is detected, a process of correcting the inconsistency is carried out after the FSD 120 is stopped.

Next described is the update difference FSCK process in detail. FIG. 12 is a flowchart illustrating an example of an update difference FSCK procedure.

[Step S121] The file allocation checking unit 131 of the FSCK executing unit 130 carries out a file allocation check. This process is described in detail later (see FIGS. 13 and 15).

[Step S122] The block allocation checking unit 132 of the FSCK executing unit 130 carries out a block allocation check. This process is described in detail later (see FIGS. 18 and 19).

[Step S123] The directory structure checking unit 133 of the FSCK executing unit 130 carries out a directory structure check. This process is described in detail later (see FIGS. 20 and 21).

Individual check processes conducted in the update difference FSCK are described next in detail. FIG. 13 is a first half of a flowchart illustrating an example of a file allocation check process.

[Step S131] The file allocation checking unit 131 reads, out of WBMAPs individually provided for the inode block areas 253 and 256 (see FIG. 7), an unread WBMAP. For example, the file allocation checking unit 131 transmits, to the storage apparatus 200, a request to refer to an unread WBMAP (WBMAP_REQ) which request designates LBAs of a corresponding inode block area. In the storage apparatus 200 after receiving WBMAP_REQ, the block update difference managing unit 241 responds to the server 100 with a WBMAP provided for an mode block area corresponding to the designated LBAs. The file allocation checking unit 131 receives the WBMAP sent from the block update difference managing unit 241.

[Step S132] The file allocation checking unit 131 acquires after images and before images associated with updated inode blocks. For example, with respect to each inode block having a bit value of “1” in the read WBMAP (i.e., with respect to each updated inode block), the file allocation checking unit 131 transmits a BIBLK reference request (BIBLK_REQ) designating an LBA of the inode block to the storage apparatus 200. In the storage apparatus 200 after receiving BIBLK_REQ, the block update difference managing unit 241 searches the B+tree 281 using the designated LBA as a key to thereby reach a leaf node containing a block number and, then, responds to the server 100 with a before image stored in a block corresponding to the block number. The file allocation checking unit 131 receives the before image sent from the storage apparatus 200. In addition, with respect to each updated inode block, the file allocation checking unit 131 transmits, to the storage apparatus 200, a request for data stored in a logical volume concerned which request designates an LBA of the updated mode block. In the storage apparatus 200, the VMGR 240 responds to the server 100 with an after image stored in a block corresponding to the designated LBA, as is the case in the normal process of accessing the logical volume. Subsequently, the file allocation checking unit 131 receives the after image sent from the storage apparatus 200.

[Step S133] The file allocation checking unit 131 holds the acquired after images and before images in a block cache area of a memory (the RAM 102). Subsequently, the file allocation checking unit 131 registers entries indicating the acquired after images and before images in block cache tables. Each block cache table is a hash table in which locations of blocks in the block cache area are identified using LBAs as keys.

At this point, the file allocation checking unit 131 reserves, in an extended attribute area of each mode held in the memory, a work area used to check a link count difference value in the directory structure check process (Step S123). The link count difference value is a difference in the number of links for a corresponding file between the previous FSCK run and the current FSCK run. A link means a directory entry for a file. More than one link may be created for a single file. That is, a single file may be listed in a plurality of directories. In this case, individual entries of the file in the directories may use different file names. In the directory structure check process to be described later, the consistency of a change in the number of links for each file is checked with the use of the reserved work area.

[Step S134] The file allocation checking unit 131 determines whether, among the WBMAPs provided for the inode block areas 253 and 256, there is yet an unread WBMAP. If there is an unread WBMAP, the process proceeds to step S131. On the other hand, if there is no unread WBMAP, the process proceeds to step S135. By the processing of steps S131 to S134, a cache for inodes having update differences is built.

[Step S135] The file allocation checking unit 131 reads an unread WBMAP out of WBMAPs provided for the inode maps in the bitmap areas 252 and 255 (see FIG. 7). For example, the file allocation checking unit 131 transmits, to the storage apparatus 200, a request to refer to an unread WBMAP (WBMAP_REQ) which request designates LBAs of a corresponding inode map. In the storage apparatus 200 after receiving WBMAP_REQ, the block update difference managing unit 241 responds to the server 100 with a WBMAP provided for an inode map corresponding to the designated LBAs. The file allocation checking unit 131 receives the WBMAP sent from the block update difference managing unit 241.

[Step S136] The file allocation checking unit 131 acquires after images and before images associated with updated inode map blocks. For example, with respect to each inode map block having a bit value of “1” in the read WBMAP (i.e., with respect to each updated inode map block), the file allocation checking unit 131 transmits a BIBLK reference request (BIBLK_REQ) designating an LBA of the inode map block to the storage apparatus 200. In the storage apparatus 200 after receiving BIBLK_REQ, the block update difference managing unit 241 searches the B+tree 281 using the designated LBA as a key to thereby reach a leaf node containing a block number and, then, responds to the server 100 with a before image stored in a block corresponding to the block number. The file allocation checking unit 131 receives the before image sent from the storage apparatus 200. In addition, with respect to each updated inode map block, the file allocation checking unit 131 transmits, to the storage apparatus 200, a request for data stored in a logical volume concerned which request designates an LBA of the updated mode map block. In the storage apparatus 200, the VMGR 240 responds to the server 100 with an after image stored in the block corresponding to the designated LBA, as is the case in the normal process of accessing the logical volume. Subsequently, the file allocation checking unit 131 receives the after image sent from the storage apparatus 200.

[Step S137] The file allocation checking unit 131 holds the acquired after images and before images of the updated inode map blocks in the block cache area of the memory (the RAM 102). Subsequently, the file allocation checking unit 131 registers entries indicating the acquired after images and before images of the updated inode map blocks in the block cache tables.

[Step S138] As for an inode corresponding to each bit of the acquired inode map blocks, the file allocation checking unit 131 initializes, to zero, a link count difference value of the inode held in the block cache area. Within the inode, the link count difference value is provided in the work area reserved in the extended attribute area.

[Step S139] The file allocation checking unit 131 determines whether, among the WBMAPs provided for the inode maps of the bitmap areas 252 and 255, there is yet an unread WBMAP. If there is an unread WBMAP, the process proceeds to step S135. On the other hand, if there is no unread WBMAP, the process proceeds to step S141 (see FIG. 15).

By the processing of steps S135 to S139, a cache for inode map blocks having update differences is built.

In the above-described manner, each pair of an after image including an updated inode and a corresponding before image and each pair of an after image including an updated inode map block and a corresponding before image are cached, in blocks, in the RAM 102 of the server 100. Access to the cached blocks and inodes included in the cached blocks is achieved with the use of cache tables.

FIG. 14 illustrates an example of a cached block and cache tables. FIG. 14 depicts an example in which a block in an inode block area has been cached. A block (cached block) 30 read from the storage apparatus 200 includes an inode image (cached inode) 31, which contains an extended attribute area 31a. According to the second embodiment, a work area for managing the link count difference value is provided in the extended attribute area.

A storage location of the block 30 is managed by block cache tables 40 and 40-1. For example, the after-image block cache table 40 and the before-image block cache table 40-1 are provided. The after-image block cache table 40 is a management table for identifying a location of a block in the memory using an LBA of the block as a key. For example, the after-image block cache table 40 includes a plurality of hash values obtained from calculation using the LBA and a predetermined hash function. Entries 42 and 43 of the block corresponding to the LBA, based on which the hash values 41 are obtained, are associated with the hash values 41. The entries 42 and 43 contain the corresponding LBA and a pointer to the cached block. The before-image block cache table 40-1 has the same configuration as the after-image block cache table 40.

In addition, inode cache tables 50 and 50-1 are provided in order to identify an inode in the block 30. For example, the after-image inode cache table 50 and the before-image block cache table 50-1 are provided. The after-image inode cache table 50 is a management table for identifying a location of an inode in the memory using an inode number of the inode as a key. For example, the after-image inode cache table 50 includes a plurality of hash values 51 obtained from calculation using the inode number and a predetermined hash function. Entries 52 to 54 of an inode image corresponding to the mode number, based on which the hash values 51 are obtained, are associated with the hash values 51. The entries 52 to 54 contain the corresponding inode number and a pointer to the cached inode image. The before-image inode cache table 50-1 has the same configuration as the after-image inode cache table 50.

Note that each of the correlation of hash values and an entry and the correlation of neighboring entries is implemented by, for example, a doubly linked list (DLL). Tracing links from hash values allows entries of a block or an inode, for which the hash values are obtained, to be found. For example, in the case of acquiring a cached after-image block, the file allocation checking unit 131 calculates hash values using an LBA of the block. Next, in the after-image block cache table 40, the file allocation checking unit 131 traces links from the obtained hash values and searches for entries corresponding to the LBA. Subsequently, the file allocation checking unit 131 acquires a block located at a position indicated by a pointer of the entries.

Although FIG. 14 only depicts the cache structure for an acquired inode block, an acquired inode map block is managed using the same cache structure. Using these cached blocks, the file allocation consistency is checked.

FIG. 15 is a second half of the flowchart illustrating the example of the file allocation check process.

[Step S141] The file allocation checking unit 131 checks whether a cached inode corresponding to update difference of each of the inode map blocks is absent. The update difference of an inode map block means a difference between the after image and the before image (bits having different values) of the inode map block. If the consistency of the file system has been maintained, there is a cached inode corresponding to the difference. Therefore, in the case where a corresponding cashed inode does not exist, it is determined that there is an inconsistency in the file system. If a cached inode corresponding to the update difference is absent, the process proceeds to step S148. On the other hand, if a cached inode corresponding to the update difference is present, the process proceeds to step S142.

[Step S142] The file allocation checking unit 131 selects a check-target inode pair from inode pairs for which file allocation has not been checked. An mode pair means a pair of an after image and a before image corresponding to the same inode number.

[Step S143] The file allocation checking unit 131 determines whether, as for the selected inode pair, a change in the bit of a corresponding inode map block is other than “0 to 1” when the inode is a newly created inode. A newly created inode is an inode whose type has changed from “0 to non 0”. Type “0” indicates that the inode is not in use. On the other hand, Type “non 0” indicates that the inode is in use. For example, a user file has an inode with Type “1”, and a directory has an inode with Type “2”. On the other hand, bit “0” in an inode map means that there is no inode, and bit in an inode map means that there in an inode. Therefore, if a change in the bit of a corresponding mode map block is other than “0 to 1” even though a change in the type of the selected inode pair indicates that the inode has been newly created, there is an inconsistency in the file system. In the case where such an inconsistency is detected, the process proceeds to step S148. On the other hand, if no inconsistency is detected, the process proceeds to step S144.

[Step S144] The file allocation checking unit 131 determines whether, as for the selected inode pair, a change in the bit of a corresponding inode map block is other than “1 to 0” when the inode is a deleted mode. A deleted inode is an inode whose type has changed from “non 0 to 0”. If a change in the bit of a corresponding inode map block is other than “1 to 0” even though a change in the type of the selected inode pair indicates that the inode has been deleted, there is an inconsistency in the file system. In the case where such an inconsistency is detected, the process proceeds to step S148. On the other hand, if no inconsistency is detected, the process proceeds to step S145.

[Step S145] The file allocation checking unit 131 determines whether, as for the selected inode pair, there is a change in the bit of a corresponding mode map block when the inode is an updated inode. An updated inode is an inode whose information has been updated without a change in the type. In the case of an mode associated with a file, for example, when data of the file is increased and then the data is stored in a new block, information for identifying the block is added to the inode. Even when the content of the inode is updated, the bit of an inode map block corresponding to the inode is not changed. If the bit of a corresponding inode map block has been changed even though the change in the selected inode pair indicates that the content of the inode has been updated, there is an inconsistency in the file system. In the case where such an inconsistency is detected, the process proceeds to step S148. On the other hand, if no inconsistency is detected, the process proceeds to step S146.

[Step S146] The file allocation checking unit 131 determines whether there is an unchecked inode pair. If there is an unchecked inode pair, the process proceeds to step S142. On the other hand, if there is no unchecked inode pair, the process proceeds to step S147.

[Step S147] The file allocation checking unit 131 sets an exit code of the FSCK to “success”. Subsequently, the process proceeds to step S149.

[Step S148] When detecting an inconsistency in one of the checking processes in steps S141, S143 to S145, the file allocation checking unit 131 sets the exit code to “error”.

[Step S149] The file allocation checking unit 131 discards the cached inode map blocks.

Thus, the consistency between changes in allocation of inodes and changes in corresponding inode map blocks is checked. Then an inconsistency is detected if there is an inconsistent inode, and the exit code is set to “error”. That is, the file allocation consistency is checkable based on update differences in the file system.

The block allocation check process is described next in detail. Note that the block allocation check process uses a block allocation map (VBMAP) and a block release map (VFBMAP) provided for each logical volume.

FIG. 16 illustrates an example of a VBMAP. A VBMAP 61 is a bitmap indicating whether each block included in an associated logical volume is a block newly allocated to a file after the previous FSCK. For example, each bit corresponding to a block newly allocated to a file after the previous FSCK is set to “1”, and each bit corresponding to a block not allocated to a file is set to “0”.

In the example of FIG. 16, the VBMAP 61 is a variable-length array of 64 bit integers. That is, each entry of the VBMAP 61 is represented by a 64-bit integer. The number of entries is obtained by dividing the volume size of the logical volume by a block size and further dividing the result by the number of bits per entry (64). A single entry indicates new allocation or not with respect to each of 64 blocks. In the case of arranging the entries in ascending order from the 0^{th} entry, for example, the N^{th} entry (N is an integer equal to or greater than 0) indicates new allocation or not for each of the (64×N)^{th} block to the (64×N+63)^{th} block.

FIG. 17 is an example of a VFBMAP. A VFBMAP 62 is a bitmap indicating whether each block included in an associated logical volume is a block released after the previous FSCK. For example, each bit corresponding to a block whose allocation to a file has been cancelled after the previous FSCK is set to “1”, and each bit corresponding to a block whose allocation has not been cancelled is set to “0”.

In the example of FIG. 17, the VFBMAP 62 is a variable-length array of 64 bit integers. That is, each entry of the VFBMAP 62 is represented by a 64-bit integer. The number of entries is obtained by dividing the volume size of the logical volume by a block size and further dividing the result by the number of bits per entry (64). A single entry indicates allocation cancel or not with respect to each of 64 blocks. In the case of arranging the entries in ascending order from the 0^{th} entry, for example, the N^{th} entry (N is an integer equal to or greater than 0) indicates allocation cancel or not for each of the (64×N)^{th} block to the (64×N+63)^{th} block.

FIG. 18 is a first half of a flowchart illustrating an example of a block allocation check process.

[Step S161] The block allocation checking unit 132 creates the VBMAP 61 and the VFBMAP 62 in the memory (RAM 102). Then, the block allocation checking unit 132 initializes values of all the bits in the VBMAP 61 and the VFBMAP 62 to zero.

[Step S162] The block allocation checking unit 132 selects a check-target inode pair (AI and BI) from inode pairs for which block allocation has not been checked. For example, the block allocation checking unit 132 sets, as check targets, inode pairs having update differences and cached during the file allocation check process, and then selects one from the inode pairs.

[Step S163] The block allocation checking unit 132 selects one LBA. For example, the block allocation checking unit 132 sequentially selects, from LBAs of the selected inode pair, one LBA in ascending order starting from the smallest LBA toward the largest LBA.

[Step S164] The block allocation checking unit 132 determines whether an allocation state of a block corresponding to the selected LBA with respect to a file is the same between the after image and the before image of the selected inode pair. The allocation state is the same, for example, when the block of the selected LBA is allocated in both the after image and the before image of the selected inode pair, or when the block of the selected LBA is allocated in neither the after image nor the before image of the selected inode pair. If the allocation state is the same, the process proceeds to step S169. On the other hand, if the allocation state is different, the process proceeds to step S165.

[Step S165] The block allocation checking unit 132 determines whether the block of the selected LBA is allocated in the before image of the selected mode pair. In the case where the block of the selected LBA is allocated in the before image while being not allocated in the after image, it is considered that the block has been released after the previous FSCK. If the block of the selected LBA is allocated in the before image, the process proceeds to step S166. On the other hand, if the block of the selected LBA is not allocated in the before image, the process proceeds to step S167.

[Step S166] The block allocation checking unit 132 sets, in the VFBMAP 62, a bit corresponding to the selected LBA to “1”.

[Step S167] The block allocation checking unit 132 determines whether the block of the selected LBA is allocated in the after image of the selected mode pair. In the case where the block of the selected LBA is allocated in the after image while being not allocated in the before image, it is considered that the block has been newly allocated after the previous FSCK. If the block of the selected LBA is allocated in the after image, the process proceeds to step S168. On the other hand, if the block of the selected LBA is not allocated in the after image, the process proceeds to step S169.

[Step S168] The block allocation checking unit 132 sets, in the VBMAP 61, a bit corresponding to the selected LBA to “1”.

[Step S169] The block allocation checking unit 132 determines whether there is an unchecked LBA. If there is an unchecked LBA, the process proceeds to step S163. On the other hand, if there is no unchecked LBA, the process proceed to step S170.

[Step S170] The block allocation checking unit 132 determines whether a value obtained by subtracting the number of released blocks from the number of allocated blocks matches difference in the number of blocks in the inode pairs. For example, the block allocation checking unit 132 recognizes the count of bits set to “1” in the VBMAP 61 as “the number of allocated blocks”, and also recognizes the count of bits set to “1” in the VFBMAP 62 as “the number of released blocks”. Then, using these values obtained from the VBMAP 61 and VFBMAP 62, the block allocation checking unit 132 calculates the value obtained by subtracting the number of released blocks from the number of allocated blocks. In addition, with respect to all of the already selected inode pairs, the block allocation checking unit 132 subtracts the total number of blocks allocated in the before images from the total number of blocks allocated in the after images. The subtraction result represents the “difference in the number of blocks in the inode pairs”. Then, the block allocation checking unit 132 compares the calculation result obtained by subtracting the number of released blocks from the number of allocated blocks against the difference in the number of blocks in the inode pairs, to thereby determine whether the two match each other. If the two match each other, the process proceeds to step S171. On the other hand, if the two do not match each other, the process proceeds to step S186 (see FIG. 19).

[Step S171] The block allocation checking unit 132 determines whether there is an unchecked inode pair. If there is an unchecked inode pair, the process proceeds to step S162. On the other hand, if there is no unchecked inode pair, the process proceeds to step S181 (see FIG. 19).

FIG. 19 is a second half of the flowchart illustrating the example of the block allocation check process.

[Step S181] The block allocation checking unit 132 reads an unread WBMAP out of WBMAPs provided for the block bitmaps 252b (see FIG. 8) in the bitmap areas 252 and 255. For example, the block allocation checking unit 132 transmits, to the storage apparatus 200, a request to refer to an unread WBMAP (WBMAP_REQ) which request designates LBAs of a corresponding block bitmap. In the storage apparatus 200 after receiving WBMAP_REQ, the block update difference managing unit 241 responds to the server 100 with a WBMAP provided for a block bitmap corresponding to the designated LBAs. The block allocation checking unit 131 receives the WBMAP sent from the block update difference managing unit 241.

[Step S182] The block allocation checking unit 132 acquires after images and before images associated with updated blocks of the block bitmap. For example, with respect to each block having a bit value of “1” in the read WBMAP (i.e., with respect to each updated block) provided for the block bitmap, the block allocation checking unit 132 transmits a BIBLK reference request (BIBLK_REQ) designating an LBA of the block to the storage apparatus 200. In the storage apparatus 200 after receiving BIBLK_REQ, the block update difference managing unit 241 searches the B+tree 281 using the designated LBA as a key to thereby reach a leaf node containing a block number and, then, responds to the server 100 with a before image stored in a block corresponding to the block number. The block allocation checking unit 132 receives the before image sent from the storage apparatus 200. In addition, with respect to each updated block, the block allocation checking unit 132 transmits, to the storage apparatus 200, a request for data stored in a logical volume concerned which request designates an LBA of the updated block. In the storage apparatus 200, the VMGR 240 responds to the server 100 with an after image stored in the block corresponding to the designated LBA, as is the case in the normal process of accessing the logical volume. Subsequently, the block allocation checking unit 132 receives the after image sent from the storage apparatus 200.

[Step S183] The block allocation checking unit 132 holds the acquired after images and before images in the block cache area of the memory (the RAM 102). Subsequently, the block allocation checking unit 132 registers entries indicating the acquired after images and before images in the block cache table.

[Step S184] The block allocation checking unit 132 determines whether, among the WBMAPs provided for the block bitmaps, there is yet an unread WBMAP. If there is an unread WBMAP, the process proceeds to Step S181. On the other hand, if there is no unread WBMAP, the process proceeds to step S185.

By the processing of steps S181 to S184, a cache for block bitmap blocks having update differences is built.

[Step S185] With respect to the number of before images in the block bitmaps, the block allocation checking unit 132 adds thereto the count of bits set to “1” in the VBMAPs and subtracts therefrom the count of bits set to “1” in the VFBMAPs. Subsequently, the block allocation checking unit 132 determines whether the calculation result matches the number of after images in the bitmaps. If the two match each other, the process proceeds to step S187. On the other hand, if the two do not match each other, the process proceeds to step S186.

[Step S186] When detecting an inconsistency in one of steps S170 and S185, the block allocation checking unit 132 sets the exit code to “error”.

[Step S187] The block allocation checking unit 132 discards the VBMAPs and the VFBMAPs.

Thus, changes in block allocation to files indicated in inodes are reflected on the number of before images in block bitmaps. Then, it is determined whether the reflected result matches the number of after images in the block bitmaps, to thereby check the block allocation consistency. That is, the block allocation consistency is checkable using information on update differences in the file system.

The directory structure check process is described next in detail. FIG. 20 is a first half of a flowchart illustrating an example of a directory structure check process.

[Step S191] The directory structure checking unit 133 selects one directory-type inode pair from mode pairs for which a directory structure check has not been checked.

[Step S192] The directory structure checking unit 133 selects one LBA. For example, the directory structure checking unit 133 sequentially selects, from LBAs of the selected inode pair, one LBA in ascending order starting from the smallest LBA toward the largest LBA.

[Step S193] The directory structure checking unit 133 determines whether an allocation state of a block corresponding to the selected LBA with respect to a file is the same between the after image and the before image of the selected inode pair. The allocation state is the same, for example, when the block of the selected LBA is allocated in both the after image and the before image of the selected inode pair, or when the block of the selected LBA is allocated in neither the after image nor the before image of the selected inode pair. If the allocation state is the same, the process proceeds to step S194. On the other hand, if the allocation state is different, the process proceeds to step S195.

[Step S194] The directory structure checking unit 133 determines whether a bit corresponding to the selected LBA in a WBMAP concerned is set to “0” (non-updated). If the corresponding bit is set to “0”, the process proceeds to step S198. On the other hand, if the corresponding bit is set to “1”, the process proceeds to step S195.

[Step S195] As for a directory entry file in the block of the selected LBA, the directory structure checking unit 133 identifies added and deleted entries. By comparing after-image and before-image directory entry files of the LBA block, the directory structure checking unit 133 is able to identify individual entries having been added, deleted, or updated. For example, if an entry included in the after-image directory entry file is not included in the before-image directory entry file, the entry is an added entry. In addition, if an entry included in the before-image directory entry file is not included in the after-image directory entry file, the entry is a deleted entry.

[Step S196] With respect to each added entry, the directory structure checking unit 133 reflects the increase to the link count difference value (i.e., increments the link count difference value by one) in the work area of an inode corresponding to the entry.

[Step S197] With respect to each deleted entry, the directory structure checking unit 133 reflects the decrease to the link count difference value (i.e., decrements the link count difference value by one) in the work area of an inode corresponding to the entry.

[Step S198] The directory structure checking unit 133 determines whether there is an unchecked LBA. If there is an unchecked LBA, the process proceeds to step S192. On the other hand, if there is no unchecked LBA, the process proceeds to step S199.

[Step S199] The directory structure checking unit 133 determines whether there is an unchecked inode pair. If there is an unchecked inode pair, the process proceeds to step S191. On the other hand, if there is no unchecked inode pair, the directory structure checking unit 133 brings all inode pairs back to an unchecked state and then proceeds to step S201 (see FIG. 21).

FIG. 21 is a second half of the flowchart illustrating the example of the directory structure check process.

[Step S201] The directory structure checking unit 133 selects one unchecked inode pair.

[Step S202] As for the selected inode pair, the directory structure checking unit 133 compares the link count difference value in the work area reserved in the after-image inode against a change in the number of links (reference count) to the individual inodes (i.e., the after-image and before-image inodes) of the inode pair. Then, the directory structure checking unit 133 determines whether the link count difference value and the change in the number of links match each other. The change in the number of links to the individual inodes of the inode pair is obtained by subtracting the number of links to the before-image inode of the inode pair from the number of links to the corresponding after-image inode. If the link count difference value matches the change in the number of links, the process proceeds to step S203. On the other hand, if the link count difference value does not match the change in the number of links, it is considered that there is an inconsistency and then the process proceeds to step S204.

[Step S203] The directory structure checking unit 133 determines whether there is an unchecked inode pair. If there is an unchecked inode pair, the process proceeds to step S201. On the other hand, if there is no unchecked inode pair, the directory structure checking unit 133 ends the directory structure check process.

[Step S204] The directory structure checking unit 133 sets an exit code to “error”, and ends the directory structure check process.

Thus, the directory structure consistency is checkable based on update differences in the file system.

As described above, according to the second embodiment, the file system consistency is checked for information of update differences generated after the previous FSCK run. Therefore, compared to the case of running the consistency check for the entire logical volumes, the amount of data to be processed is reduced, enabling the consistency check to be completed in a short time. Furthermore, because a FSCK is run when the number of updated blocks reaches or exceeds a predetermined upper limit, the amount of data processed in each FSCK does not change even if the size of the volumes increases. As a result, it is possible to control an increase in the FSCK run time associated with enlargement of the volume capacity.

Note that the operation of the FSD is stopped during the FSCK according to the second embodiment, however, the time of stopping the FSD during the FSCK may be shortened. For example, in the above-described process for suspending the FSD, a volume image is frozen with the use of an online snapshot function provided with the VMGR after a buffer cache and the like are flushed, and the frozen image is used as a target of the FSCK. Note that flushing is a process of writing data temporarily held in the server 100 out to a storage apparatus. Using the frozen image as a target of the FSCK allows the FSD to resume operations after the frozen image is created. As a result, the FSD is stopped only for the period of time taken to create the frozen image, thus shortening the time for the FSD to be stopped.

According to one aspect, it is possible to control an increase in the time for file system verification.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. A file system verification method comprising:
identifying, by a processor, among a plurality of unit storage areas in a volume storing therein one or more pieces of management object information managed by a file system and one or more pieces of management information corresponding one-to-one with the management object information pieces and used to manage the corresponding management object information pieces, one or more unit storage areas whose information has been updated within a predetermined time frame; and
verifying, by the processor, consistency between the management object information pieces and the management information pieces in the file system using the information of the identified unit storage areas.

2. The file system verification method according to claim 1, wherein:
the verifying includes:
acquiring, from each of the identified unit storage areas, first information being stored at start of the predetermined time frame and second information being stored at end of the predetermined time frame; and
verifying, based on the first information and the second information, consistency between changes in the management object information pieces and changes in the management information pieces within the predetermined time frame.

3. The file system verification method according to claim 1, wherein:
the verifying includes verifying consistency between changes in first allocation information and changes in the management information pieces within the predetermined time frame, the first allocation information indicating allocation or non-allocation of each of the management information pieces to the corresponding management object information piece.

4. The file system verification method according to claim 1, wherein:
the verifying includes verifying consistency between changes in second allocation information and changes in allocation of the plurality of unit storage areas to the management object information pieces within the predetermined time frame, the second allocation information indicating allocation or non-allocation of each of the plurality of unit storage areas to the management object information pieces, and the changes in allocation being indicated by the corresponding management information pieces.

5. The file system verification method according to claim 1, wherein:
the verifying includes verifying consistency between changes in unit storage areas allocated to the management object information pieces and changes in a number of the unit storage areas allocated to the management object information pieces within the predetermined time frame, the changes in a number being indicated by the corresponding management information pieces.

6. The file system verification method according to claim 1, wherein:
the verifying includes verifying consistency between changes in a number of directories to which each file belongs, which changes are based on changes in entries of the file to the directories within the predetermined time frame, and the changes in a number within the predetermined time frame, indicated by a management information piece corresponding to the file.

7. The file system verification method according to claim 1, further comprising:
entering, by a storage apparatus provided with the volume or the information processing apparatus, on updated area information, a record regarding information update of each unit storage area when the information of the unit storage area is updated within the predetermined time frame,
wherein the identifying includes identifying the unit storage area whose information has been updated within the predetermined time frame by reference to the updated area information.

8. The file system verification method according to claim 1, further comprising:
storing, by a storage apparatus provided with the volume or the information processing apparatus, pre-update information of each unit storage area in a storage unit when the information of the unit storage area is updated within the predetermined time frame,
wherein the verifying includes verifying the consistency based on a result of comparing the pre-update information stored in the storage unit and corresponding updated information stored in the volume.

9. The file system verification method according to claim 1, wherein:
the verifying is performed when a number of unit storage areas whose information has been updated exceeds a predetermined value.

10. A computer-readable storage medium storing a computer program, the computer program causing an information processing apparatus to perform a procedure comprising:
identifying, among a plurality of unit storage areas in a volume storing therein one or more pieces of management object information managed by a file system and one or more pieces of management information corresponding one-to-one with the management object information pieces and used to manage the corresponding management object information pieces, one or more unit storage areas whose information has been updated within a predetermined time frame; and
verifying consistency between the management object information pieces and the management information pieces in the file system using the information of the identified unit storage areas.

11. An information processing apparatus comprising:
a processor configured to perform a procedure including:
identifying, among a plurality of unit storage areas in a volume storing therein one or more pieces of management object information managed by a file system and one or more pieces of management information corresponding one-to-one with the management object information pieces and used to manage the corresponding management object information pieces, one or more unit storage areas whose information has been updated within a predetermined time frame; and
verifying consistency between the management object information pieces and the management information pieces in the file system using the information of the identified unit storage areas.
